(19) United States
(12) Patent Application Publication
(10) Pub. No.: US 2007/0205152 A1
(43) Pub. Date: Sep. 6, 2007

(54) Process for biological purification of waste water with simultaneous decomposition of organic and nitrogen-containing compounds

(76) Inventors: Anton Jell, Poing (DE); Manfred Morper, Starnberg (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/503,202

(22) Filed: Aug. 14, 2006

(30) Foreign Application Priority Data
Mar. 3, 2006 (DE) 102006009878.1

(51) Int. Cl. C02F 3/00

(52) U.S. Cl. 210/616

(57) ABSTRACT

For the biological purification of waste water that contains organic and nitrogen-containing compounds, wastewater is aerated with air and/or oxygen in the presence of a biomass fixed on a carrier material 9 in a reactor 1 through which flow takes place lengthwise and then is separated in a secondary clarification 5 into purified water and sludge. The separated sludge is at least partially returned again to the reactor 1. Carrier particles in an amount that can move freely in the waste water are introduced into the reactor as carrier material 9 for the microorganisms. To enable the decomposition of both the organic compounds and the nitrogen-containing compounds simultaneously. In the reactor 1, a cylindrical flow 10 of the mobile reactor contents is produced by aeration perpendicular to the flow direction in the reactor 1. To do this, there are gassing surfaces 11 that are largely continuous in the flow direction of the reactor 1 and to which ungassed surfaces 12 are adjacent perpendicularly to the flow direction. In the rising flow over the gassing surfaces 11, thus favorable prerequisites for nitrification are established, while in the descending flow, denitrification processes are promoted over the surfaces 12 that are free of gassing.

The invention relates to a process for biological purification of waste water that contains organic and nitrogen-containing compounds, in which the waste water is aerated with air and/or pure oxygen in the presence of a biomass fixed on a carrier material in a reactor through which flow takes place lengthwise and then is separated in secondary clarification into purified water and sludge, and the separated sludge is at least partially returned again to the reactor, and in which carrier particles in an amount that can move freely in the waste water are introduced into the reactor as carrier material for the microorganisms.

In processes employing carrier-bound waste water purification, the biomass formed from the microorganisms is present in part in the form of suspended sludge flakes (activated sludge) and in part fixed on the carrier material that can move freely in the reactor. As carrier material, e.g., lumpy, porous foam particles can be used. Waste water and suspended biomass flow out of the reactor to secondary clarification, where they are mechanically separated by, e.g., sedimentation. The separated biomass is in part recycled as return sludge to the reactor and in part is discharged as excess sludge and disposed of. The fixed biomass is prevented from leaving the reactor by mechanical retention of the carrier particles (e.g., by means of a screen wall).

Such a process is known from EP 0 233 466 B1. The process described there eliminates a disadvantage of conventional processes requiring large reaction volumes for biological elimination of organic contents and nitrogen compounds. This is substantiated in that the biological elimination of the nitrogen—present as ammonium—takes place via two successive biochemical reactions that require different reaction conditions.

First, ammonium (NH₄⁺) is oxidized into nitrate (nitrification) by special bacteria fed with oxygen. The nitrate is then reduced by denitrification with other bacteria into elementary nitrogen (N₂), with preferably the organic substances contained in the inflowing waste water being used as reducing agents.

Since nitrification as aerobic oxidation is dependent on a sufficient supply of oxygen, while anaerobic denitrification assumes oxygen-free, or at least low-oxygen reaction conditions, a system for biological nitrogen elimination must have both volumetric components with increased contents of dissolved oxygen and also those with contents of dissolved oxygen that are as low as possible.

While conventional systems (see ATV-DVWK Regulations, Sheet A131) maintain these contrary reaction conditions either in separate reactors, or by operating a reactor sequentially by turning the aeration on and off in large reactor volumes, a high degree of nitrogen elimination, according to EP 0 233 466 B1, can be achieved simultaneously in one reactor. The latter system is accomplished by providing zones with different contents of dissolved oxygen in a reactor (activated sludge tank) in the direction of flow. This is achieved by providing an air and oxygen supply that is different each time. In zones with a high oxygen content, nitrification preferably takes place. Conversely, in zones with a low oxygen content, at least partial denitrification is achieved without a separate tank volume being needed for this portion. Irrespective of the undisputed saving of reactor volume, a system according to EP 0 233 466 B1 has a series of operating disadvantages:

If, for example, according to the embodiment set forth in EP 0 233 466 B1, first a zone with low oxygen content, therefore reduced oxygen supply, is operated in the flow direction, thus the denitrification desired is dependent on a sufficient nitrate return from zones with a high oxygen content where nitrate formation occurs. The zone having a low oxygen concentration is accompanied by poor mixing and leads to floating of carrier particles due to the flotation effect of the nitrogen bubbles that form in denitrification. The carrier particles that accumulate as a floating cover no longer participate in the conversion of materials.

In the aerobic zone following the zone with low oxygen content, a high nitrification rate is achieved, but denitrification is largely suppressed. The energy density that accompanies intensive aeration in the activated sludge tank leads to a shift of the carrier material into the zones with low energy density and intensifies the formation of a floating cover there. Moreover, displacement leads to a reduction of the nitrification capacity since the nitrifying bacteria fixed on this carrier material portion are not available for nitrification.

The following zone with a repeated again low oxygen content receives a nitrate-containing inflow from the upstream, highly aerobic zone. Still, denitrification is limited since the preceding zones have largely decomposed the organic carbon compounds that are required as reducing agents. Due to the mixing energy that is low due to the low oxygen demand, the tendency to cause floating of the carrier material is especially high.

A main object of the present invention is to provide an improved wastewater treatment having at least one advantage.

Other objects are to provide a process which decreases nitrate return from zones with high aeration into those with reduced aeration and to eliminate capacity losses in denitrification by floating carrier material and in nitrification by displacement of carrier material out of zones with a high energy density.

Still other objects and advantages of the invention are discussed in the following description and appended claims.

To achieve one or more objects of the invention, a process is provided comprising a simultaneous decomposition of organic and nitrogen-containing compounds by conducting the following:
a) maintaining continuous aeration that extends in the flow direction over at least one aeration surface that runs lengthwise to the flow direction on the reactor bottom,
b) providing at least one unaerated adjacent, free surface in the perpendicular direction to the flow direction of the aeration surface, and
c) providing a cylindrical flow of mobile reactor contents to create sequentially a flow over the aeration surface, a flow on the surface of the reactor contents horizontally in the direction of the free surface, a flow down over the free surface, and then a flow on the reactor bottom horizontally to the aeration surface.

The invention permits simultaneous decomposition of organic and nitrogen-containing compounds in the reactor by setting of defined hydraulic profiles involving choosing a suitable aeration method. To do this, the aeration characteristics that are necessary according to the oxygen demand (e.g., fine-bubble or coarse-bubble pipe, plate or disk aerators, ejectors, static mixing aerators) on the bottom of a reactor made, for example, as an activated-sludge tank, are arranged as aeration surfaces that are largely continuous in the flow direction, and that can be made, for example, as aerator fields. Parallel, next to and between the aerator fields on the tank bottom, there remain unoccupied surfaces that have a width of preferably at least 0.5 m and that correspond at most to the width of the aerator fields. With air or oxygen supply, this arrangement causes formation of a closed cylindrical flow of the mobile tank contents (waste water, activated sludge, carrier material) perpendicular to the flow direction, with an upwardly directed flow over the aerator fields and a downwardly directed flow over the unactivated parts of the tank bottom. The aerator fields and free surface thus cause helical flow through the tank.

These hydraulic conditions act on the biological decomposition processes in that in the rising flow over the aerator fields, as a result of the increased content of dissolved oxygen, favorable prerequisites for nitrification both by the suspended biomass and also by the fixed biomass prevail.

Conversely, the interruption of the oxygen supply in the descending flow and in the flow returning to the aerator fields on the tank bottom leads to a reduction of the content of dissolved oxygen that is consumed essentially by the suspended biomass and the fixed biomass on the carrier material surface. In this way, in preferred use of carrier particles with internal and external growth surfaces for microorganisms, denitrification processes are promoted especially within the carrier material.

The cylindrical flow perpendicular to the flow direction leads to uniform tank mixing, the tank contents during the residence time changing repeatedly between the areas with increased and decreased content of dissolved oxygen.

By the present invention, compared to the process according to EP 0 233 466 B1, both floating covers of floating carrier material and also displacements of carrier material out of zones with high energy density are avoided. Consequently, the present invention avoids the concomitant capacity losses by carrier material portions that are not involved in the reaction.

As mentioned above, simultaneous nitrification and denitrification processes in the reactor is promoted by the preferred use of carrier particles with inner and outer growth surfaces for the microorganisms. In this connection, carrier particles can be used that have, for example, lattice structures that enable access of waste water contents to the inner regions of the carrier particles. Especially preferably, carrier particles with a pore structure are used that advantageously have micropores and macropores, by which are formed both the inner and outer growth surfaces for microorganisms thus making available sufficient access of waste water contents to the inner growth surfaces. Such carrier particles can be produced from different materials, for example from porous sintered materials or plastics.

According to one especially preferred embodiment of the invention, porous foam particles are used as carrier particles. They consist advantageously of an open-cell polyurethane foam and have particle sizes of from 2 to 50 mm and a specific weight of from 20 to 200 kg per cubic meter. The pore diameters are suitably 0.1 to 5 mm.

To support optimum hydraulic conditions, carrier particles are advantageously introduced into the reactor in an amount of from 15 to 35% of the reactor volume.

For especially effective cleaning of the waste water with simultaneous decomposition of the carbon and nitrogen compounds, it is, moreover, recommended that the BSB5 loading rate per unit volume of from 0.4 to 2.5 kg/m³×d and the TKN loading rate per unit volume of from 0.1 to 0.8 kg/m³/d be set in the reactor.

Suitably, aeration is controlled so as to maintain the area of the upwardly directed flow, a content of from 1 to 4 mg per liter of dissolved oxygen.

According to a further development of the inventive idea, continuous aeration over several surfaces that run parallel to one another and that extend in the flow direction is maintained on the reactor bottom, intermediate surfaces that lie perpendicular to the flow direction being kept free of aeration. In this way, several cylindrical flows perpendicular to the flow direction can be produced.

Another embodiment of the invention calls for a portion of from 20 to 100% relative to the reactor throughput to be returned from the end to the beginning of the reactor and to be routed there into the downwardly directed flow.

### BRIEF DESCRIPTION OF DRAWINGS

The invention is to be explained in more detail below using embodiments shown diagrammatically in the figures.

FIG. 1 is a top view of an activated-sludge treatment system with activation tanks in which a cylindrical flow is produced,

FIG. 2 is a cross-section of the activated-sludge tank perpendicular to the flow direction,

FIG. 3 is a cross-section through an activated-sludge tank perpendicular to the flow direction with two opposing cylindrical flows,

FIG. 4 is a cross-section through an activated-sludge tank perpendicular to the flow direction with two outside unaerated zones and a central aerator field.

### DETAILED DESCRIPTION OF DRAWINGS

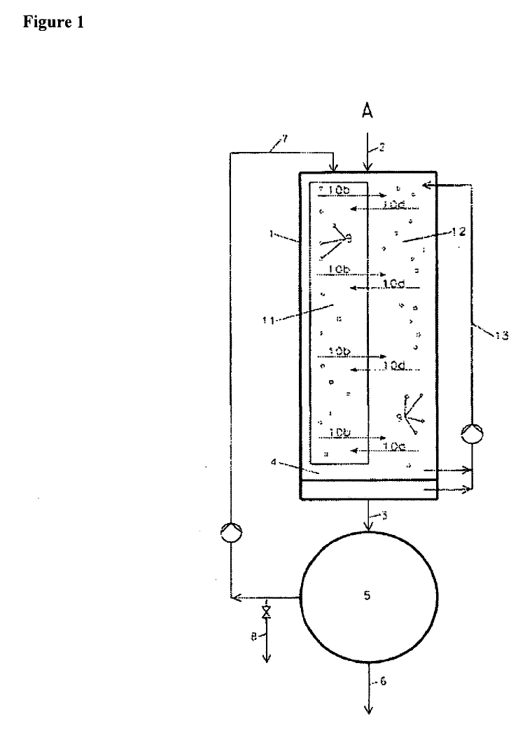

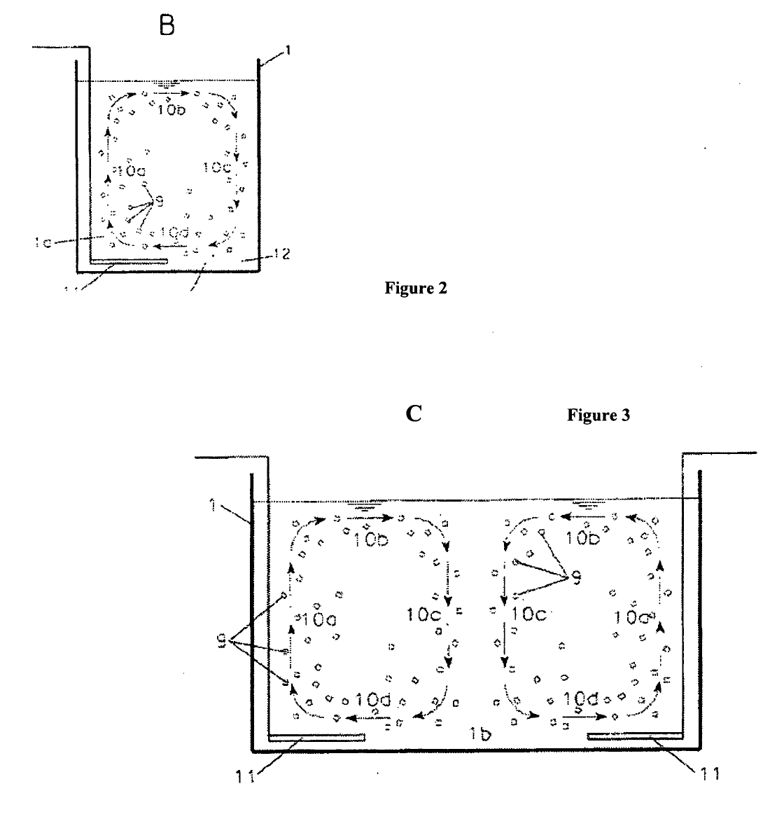

In FIG. 1, a reactor designed as a fully-mixed activated-sludge tank is labeled 1; in it, as indicated by the small squares 9, there is freely mobile carrier material for microorganisms in the form of porous cubes that consist of polyurethane foam that takes up 15 to 35% of the reactor volume. The waste water to be treated is routed via a flow inlet 2 into the activated-sludge tank 1, while the mixture of treated waste water and activated sludge is supplied to secondary clarification designed as a settling tank via a drain 3 that is located in the upper area of the activated-sludge tank and to which a separating means 4 for retaining the individual carrier material particles, e.g., in the form of a screen, is connected upstream. From there, clarified waste water flows out of the system, while the sedimented sludge is discharged in part via a sludge removal 8. The bottom of the activated-sludge tank according to FIGS. 1 and 2 is more than 50% of its width occupied by an aerator field 11, while the remaining surface of at most 50% of the width is unoccupied. The air and/or oxygen gas bubbles rising out of the aerator field 11 according to arrow 10a shift the mobile tank contents into an upwardly directed flow that is deflected on the surface horizontally to the opposing tank wall (arrow 10b). A downwardly directed flow (according to arrow 10c) is established over the free tank bottom. The suction action of the rising gas bubbles that takes effect on the tank bottom over the aerator field 11 causes horizontal flow according to arrow 10d.

Overall, a closed cylindrical flow forms perpendicular to the flow direction. The activated-sludge tank contains another return line 11 via which the nitrate-containing tank contents that have been removed upstream or downstream from the retaining means are conveyed into the downwardly directed flow part in the inflow area.

FIG. 3 shows a cross-section through the activated-sludge tank perpendicular to the flow direction with two cylindrical flows in opposite directions, in which a middle unaerated zone 12 is assigned to two aerator fields 11 on the tank edges.

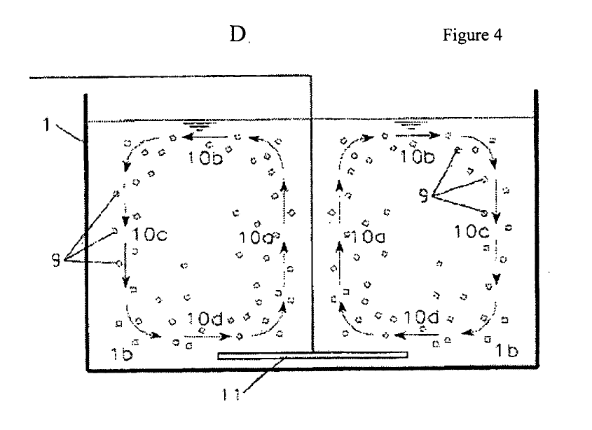

According to FIG. 4, two outside unaerated zones 12 are assigned to a middle aerator field 11; this likewise produces two cylindrical flows in opposite directions.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

The entire disclosure of all applications, patents and publications, cited herein and of corresponding German Application No. 102006009878.1, filed Mar. 3, 2006, is incorporated by reference herein.

The preceding examples can be repeated with similar success by substituting the generically or specifically described reactants and/or operating conditions of this invention for those used in the preceding examples.

From the foregoing description, one skilled in the art can easily ascertain the essential characteristics of this invention, and without departing from the spirit and scope thereof, can make various changes and modifications of the invention to adapt it to various usages and conditions.

1. In a process for biological purification of wastewater containing organic and nitrogen-containing compounds, in which the waste water is aerated with air and/or pure oxygen in the presence of a biomass fixed on a carrier material (9) in an elongated reactor (1) through which flow of wastewater is conducted lengthwise and then is separated in a secondary clarifier (5) into purified water and sludge, and the separated sludge is at least partially returned again to the reactor (1), and wherein carrier particles in an amount that can move freely in the waste water are introduced into the reactor (1) as carrier material (9) for the microorganisms, the improvement comprising maintaining the following aeration and flow conditions in the reactor (1), causing a simultaneous decomposition of organic and nitrogen-containing compounds:
a) maintaining continuous aeration that extends in the flow direction over at least one aeration surface (11) that runs lengthwise to the flow direction on the reactor bottom,
b) providing of at least one unaeration adjacent free surface (12) in the perpendicular direction to the flow direction of the aeration surface (11), and
c) providing a cylindrical flow (10 a, b, c, d) of the mobile reactor contents aerating sequentially an upward flow over the aeration surface (11) a flow on the surface of the reactor contents horizontally in the direction of the free surface (12), a flow down over the free surface (12), and a flow on the reactor bottom horizontally to the gassing surface (11).

2. A process according to claim 1, wherein said carrier particles (9) comprise internal and external growth surfaces for the microorganisms are used.

3. A process according to claim 2, wherein said carrier particles comprises porous foam particles.

4. A process according to claim 1, wherein carrier particles (9) are introduced in an amount of from 15 to 35% of the reactor volume.

5. A process according to claim 1, comprising conducting the process with a BSB5 loading rate per unit volume of from 0.4 to 2.5 kg/m³×d and a TKN loading rate per unit volume of from 0.1 to 0.8 kg/m³/d.

6. A process according to claim 1, comprising setting the aeration in the area of the upwardly-directed flow, so as to maintain a content of from 1 to 4 mg per liter of dissolved oxygen.

7. A process according to claim 1, providing continuous aeration over several aeration surfaces (11) that run parallel to one another and that extend in the flow direction on the reactor bottom, between the aeration surfaces (11) free surfaces (12) that lie adjacently perpendicular to the flow direction being kept free of aeration so as to create several cylindrical flows (10a, b, c, d) perpendicular to the flow direction.

8. A process according to claim 1, comprising returning a portion of from 20 to 100% relative to the reactor throughput from the outlet zone of the reactor to the inlet zone of the reactor and is routed to the inlet zone as a downwardly directed flow.
